(19) United States
(12) Patent Application Publication
(10) Pub. No.: US 2025/0166259 A1
(43) Pub. Date: May 22, 2025

(54) VIDEO RECORDING SYSTEM AND METHOD FOR COMPOSITING

(71) Applicant: DEEPBRAIN AI INC., Seoul (KR)

(72) Inventors: JUN SANG PARK, Seoul (KR); JONG HYEON PARK, Seoul (KR); HYE JIN JO, Seoul (KR); GYEONG SU CHAE, Seoul (KR)

(21) Appl. No.: 18/840,889

(22) PCT Filed: May 26, 2022
(86) PCT No.: PCT/KR2022/007475

§ 371 Date: Aug. 22, 2024

(30) Foreign Application Priority Data
May 17, 2022 (KR) 10-2022-0060151

(51) Int. Cl. G06T 11/60

(52) U.S. Cl. CPC G06T 11/60

(57) ABSTRACT

A video recording system for compositing includes a first monitor which is positioned in a gaze area of a user and is for outputting a live video of the user and a basic posture still image displayed to be superimposed on the live video of the user, a recording apparatus for recording the user, and an image controller for transmitting the basic posture still image and the live video of the user to the first monitor on the basis of a user video transmitted from the recording apparatus and changing the basic posture still image transmitted to the first monitor when an image conversion condition is met while recording the live video of the user.

### CROSS REFERENCE TO RELATED APPLICATIONS AND CLAIM OF PRIORITY

This application claims benefit under 35 U.S.C. 119, 120, 121, or 365 (c), and is a National Stage entry from International Application No. PCT/KR2022/007475 filed on May 26, 2022, which claims priority to the benefit of Korean Patent Application No. 10-2022-0060151 filed on May 17, 2022 in the Korean Intellectual Property Office, the entire contents of which are incorporated herein by reference.

### BACKGROUND

### 1. Technical Field

The disclosed embodiments relate to a video recording system and method for compositing.

### 2. Background Art

When training of or inferring by an image compositing artificial neural network, etc. for a person's face and body, only the face or speech part of an image containing a part or all of the person's face and body may be composited and the original image of parts other than those parts may be used as a background image, or the gesture itself of parts of the body such as the head, hands, and upper body, or the entire body may be composited and controlled. In this case, in order to ensure continuity in a composite image as if a real person speaking or moving, the gesture or background of the combined parts should be naturally connected in the sequentially composited images or images connected after compositing. To this end, it is important that a person's position and posture match at the point in time when different gestures or background images are converted.

### SUMMARY

The disclosed embodiments are intended to provide a video recording system and method for compositing to effectively control a posture of a subject to be recorded when recording a video for compositing.

A video recording system for compositing according to an embodiment includes a first monitor which is positioned in a gaze area of a user and is for outputting a live video of the user and a basic posture still image displayed to be superimposed on the live video of the user, a recording apparatus for recording the user, and an image controller for transmitting the basic posture still image and the live video of the user to the first monitor on the basis of a user video transmitted from the recording apparatus, and changing the basic posture still image transmitted to the first monitor when an image conversion condition is met while recording the live video of the user.

The basic posture still image may include a plurality of still images including a standby posture still image, a start still image of a gesture, and an end still image of a gesture, and the image controller may transmit one of the standby posture still image, the start still image of the gesture, and the end still image of the gesture, as a next basic posture still image of the current basic posture still image transmitted to the first monitor, to the first monitor when the image conversion condition is met.

The video recording system for compositing may further include a user terminal for transmitting an image conversion request to the image controller, and the image controller may determine that the image conversion condition is met when a still image of the live video of the user matches the basic posture still image, or an image conversion request is received from the user terminal, or a preset time elapses after transmitting the basic posture still image to the first monitor while recording the live video of the user.

The image controller may output a compositing criterion meeting notification when a still image of the live video of the user while recording the live video of the user meets a preset compositing criterion compared to the basic posture still image.

The image controller may output guidance on compositing criterion including at least one of a posture change portion for the still image of the live video of the user to match the basic posture still image, a description of the posture change portion, and an identification number of the posture change portion through the first monitor when a still image of the live video of the user while recording the live video of the user does not meet a preset compositing criterion compared to the basic posture still image.

The recording apparatus may include a plurality of recording apparatuses located in different areas to record videos from different angles for the user.

The image controller may manage a plurality of user videos transmitted from the plurality of recording apparatuses by dividing the plurality of user videos into one of a gesture unit and a preset length unit and matching each of the plurality of user videos with at least one of video identification and recording information apparatus's identification information.

The plurality of user videos may include videos from different angles, and the image controller may group the plurality of user videos including the videos from different angles into videos of the same angle, or group all of a plurality of user videos recorded at the same time and manage grouped videos separately.

The video recording system for compositing may further include a second monitor which is located outside a recording booth and is for receiving and outputting the same information as the output information of the first monitor transmitted from the image controller.

The video recording system for compositing may further include a recorder for receiving the user video transmitted from the recording apparatus and transmitting the user video to the image controller and a control panel for receiving control information input by a user and transmitting the control information to the image controller.

The first monitor may be located inside the recording booth.

A video recording method for compositing according to another embodiment includes recording a user video using a recording apparatus, outputting a live video of a user and a basic posture still image displayed to be superimposed on the live video of the user through the first monitor on the basis of a user video transmitted from the recording apparatus, checking whether an image conversion condition is met while recording the live video of the user, and changing the basic posture still image output through the first monitor when it is checked that the image conversion condition is met.

The basic posture still image may include a plurality of still images including a standby posture still image, a start still image of a gesture, and an end still image of a gesture, and in the changing of the basic posture still image, one of the standby posture still image, the start still image of the gesture, and the end still image of the gesture, as a next basic posture still image of the current basic posture still image is transmitted to the first monitor, to the first monitor.

In the checking of whether the image conversion condition is met, it may be determined that the image conversion condition is met when a still image of the live video of the user matches the basic posture still image, or an image conversion request is received from the user terminal, or a preset time elapses after transmitting the basic posture still image to the first monitor while recording the live video of the user.

In the checking of whether the image conversion condition is met, it may be checked whether a still image of the live video of the user while recording the live video of the user meets a preset compositing criterion compared to the basic posture still image, and when it is checked that the preset compositing criterion is met), a compositing criterion meeting notification may be output before the changing of the basic posture still image.

In the checking of whether the image conversion condition is met, it may be checked whether a still image of the live video of the user while recording the live video of the user meets a preset compositing criterion compared to the basic posture still image, and when it is checked that the preset compositing criterion is not met, in the outputting of the basic posture still image through the first monitor, guidance on compositing criterion including at least one of a posture change portion for the still image of the live video of the user to match the basic posture still image, a description of the posture change portion, and an identification number of the posture change portion may be output through the first monitor.

The recording apparatus may include a plurality of recording apparatuses located in different areas to record videos from different angles for the user, and the video recording method compositing further include d for may managing a plurality of user videos transmitted from the plurality of recording apparatuses by dividing the plurality of user videos into one of a gesture unit and a preset length unit and matching each of the plurality of user videos with at least one of video identification information and recording apparatus's identification information.

The plurality of user videos may include videos from different angles, and in the managing, the plurality of user videos including the videos from different angles may be grouped into videos of the same angle, or all of a plurality of user videos recorded at the same time may be grouped, and grouped videos may be managed separately.

The first monitor may be located inside a recording booth, and in the outputting of the live video of the user and the basic posture still image through the first monitor, the same information as the output information of the first monitor may be output through a second monitor located outside the recording booth.

According to the disclosed embodiments, since a subject to be recorded can check a recording state and control his or her posture during recording of a video for compositing, the effect can be expected that the posture of the subject to be recorded at a connecting point in different videos will match, compositing using the recorded videos will be facilitated, and natural continuity of the composited video can be secured.

In addition, according to the disclosed embodiments, since the basic posture still images to guide the posture of the subject to be recorded are provided when recording the video for compositing, the subject to be recorded can quickly and accurately perform the intended posture.

In addition, according to the disclosed embodiments, a posture matching rate of the subject to be recorded in the video recorded during repeated recording can be improved.

### BRIEF DESCRIPTION OF THE DRAWINGS

FIG. 1 is an overall exemplary diagram to which a video recording system for compositing to an embodiment is applied.

FIG. 2 is a control block diagram for describing a video recording system for compositing according to an embodiment.

FIGS. 3 to 6 are exemplary diagrams for describing a video recording method for compositing according to an embodiment.

FIG. 7 is a flowchart for describing a video recording method for compositing according to an embodiment.

FIG. 8 is a block diagram for illustratively describing a computing environment including a computing device according to an embodiment.

### DETAILED DESCRIPTION

Hereinafter, a specific embodiment of the present disclosure will be described with reference to the drawings. The following detailed description is provided to aid in a comprehensive understanding of the methods, apparatus and/or systems described herein. However, this is illustrative only, and the present disclosure is not limited thereto.

In describing the embodiments of present disclosure, when it is determined that a detailed description of related known technologies may unnecessarily obscure the subject matter of the present disclosure, a detailed description thereof will be omitted. Additionally, terms to be described later are terms defined in consideration of functions in the present disclosure, which may vary according to the intention or custom of users or operators. Therefore, the definition should be made based on the contents throughout this specification. The terms used in the detailed description are only for describing embodiments of the present disclosure, and should not be limiting. Unless explicitly used otherwise, expressions in the singular form include the meaning of the plural form. In this description, expressions such as “comprising” or “including” are intended to refer to certain features, numbers, steps, actions, elements, some or combination thereof, and it is not to be construed to exclude the presence or possibility of one or more other features, numbers, steps, actions, elements, some or combinations thereof, other than those described.

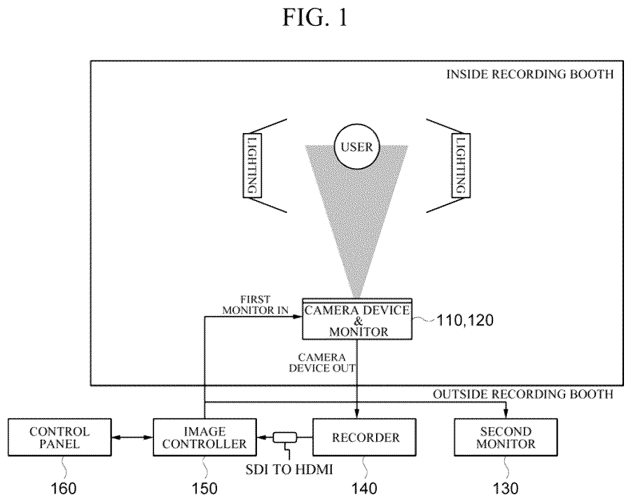

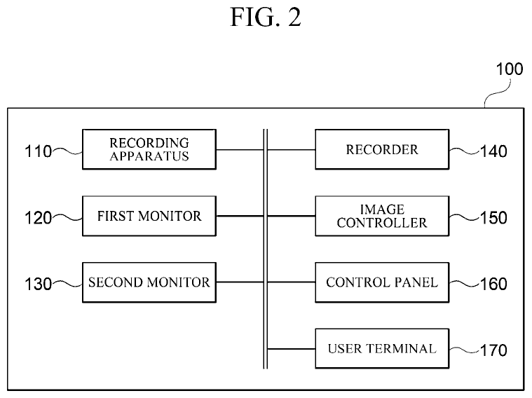

FIG. 1 is an overall exemplary diagram to which a video recording system for compositing according to an embodiment is applied and FIG. 2 is a control block diagram for describing a video recording system for compositing according to an embodiment.

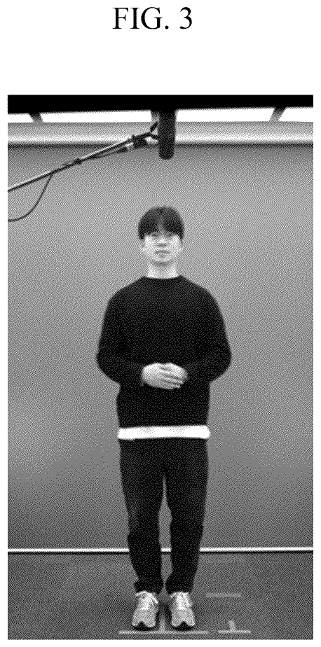

Hereinafter, description will be made with reference to FIGS. 3 to 6, which are exemplary diagrams of a video recording method for compositing according to an embodiment.

As illustrated in FIG. 1, a recording space for recording videos may be divided into the inside of recording booth for a subject to be recorded to record a video and the outside of the recording booth for control related to video recording. Hereinafter, for convenience of description, a subject to be recorded will be referred to as a user. In this case, the recording booth may be soundproofed to provide an environment optimized for video recording.

In this embodiment, in addition to performing control related to video recording in the outside of the recording booth, the user located inside the recording booth may directly perform control related to video recording. A detailed description of this will be made below.

Referring to FIG. 2, a video recording system for compositing 100 includes a recording apparatus 110, a first monitor 120, a second monitor 130, a recorder 140, an image controller 150, a control panel 160, and a user terminal 170.

The recording apparatus 110 may be configured to record a user. In FIG. 1, one recording apparatus 110 is illustrated, but is not limited to this, and the recording apparatus 110 may be provided in plural so as to record the user from various angles. In this case, each of the recording apparatuses 110 is assigned identification information and may be used to identify a recorded video.

Specifically, the recording apparatus 110 may include a plurality of recording apparatuses located in different areas to record videos from different angles user (e.g., front, side, back, plane, etc.) with respect to the user.

The first monitor 120 may be located in a gaze area of a user configured to output a live video of the user and a basic posture still image displayed to be superimposed on the live video of the user. In this case, the live video of the user may refer to real-time video being recorded through the recording apparatus 110. The basic posture still image may refer to a still image of a border portion where the videos are connected to each other when compositing the videos. That is, when multiple videos are composited, the videos may be connected in units of basic posture still images.

As illustrated in FIG. 1, the first monitor 120 may be installed in a position opposite to the user so that the user may check various information necessary for recording a video.

The first monitor 120 may be implemented as a single apparatus, such as a prompter, together with the recording apparatus 110 described above. In this case, when there are a plurality of recording apparatuses 110, one of the plurality of recording apparatuses 110 may be implemented as the prompter together with the first monitor 120. The present invention is not limited to this, and each of the plurality of recording apparatuses 110 may be implemented as the prompter together with the first monitor 120. In this case, as there are a plurality of recording apparatuses 110, there may also be a plurality of first monitors 120.

As illustrated in FIG. 1, the first monitor 120 may be located inside the recording booth.

The second monitor 130 may be located outside the recording booth and configured to receive and output the same information as the output information of the first monitor 110 transmitted from the image controller 150.

The recorder 140 may be configured to receive a user video transmitted from the recording apparatus 110 and transmit the user video to the image controller 150.

Although not illustrated, a converter may be provided between the recorder 140 and the image controller 150, so that a user video in serial digital interface (SDI) format can be converted to a high definition multimedia interface (HDMI) format and transmitted to the image controller 150. In this case, the user video output from the camera device 110 may be in the HDMI format, and the user video output from the recorder 140 may be in the SDI format.

The image controller 150 may transmit the basic posture still image and the live video of the user to the first monitor 120 on the basis of a user video transmitted from the recording and change the basic posture still image transmitted to the first monitor 120 when an image conversion condition is met while recording the live video of the user.

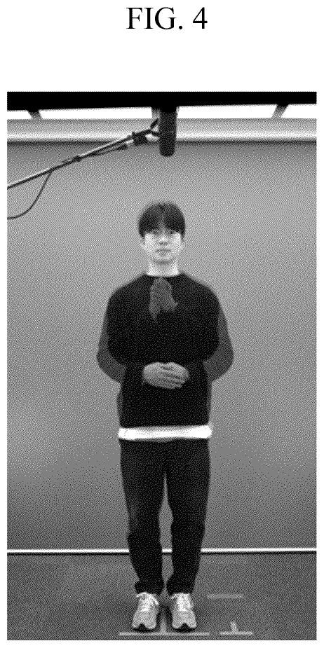

For example, the image controller 150 may set a basic posture still image as illustrated in FIG. 3 from the user video, and transmit the set basic posture still image to the first monitor 120 to be output by being superimposed on the live video of the user, as illustrated in FIG. 4. In this case, the image controller 150 may obtain the basic posture still image from the user video transmitted in real time from the camera device 110, but is not limited to this, and may obtain the basic posture still image by separately recording a basic posture still image before recording the live video of the user.

In this case, the basic posture still image is a posture criterion that is matched to ensure natural continuity of a composited portion when compositing multiple videos, and may serve as a guide to help the user assume various postures and gestures and then return. That is, when compositing multiple videos, it is possible to composite basic posture still images so that basic posture still images that match each other are connected in videos divided into basic posture still image units.

The image controller 150 may be implemented as a switcher capable of switching the camera device 110 and adjusting the degree of dissolve.

As illustrated in FIG. 1, the image controller 150 may be communicatively connected to the first monitor 120 and the second monitor 130 to transmit the basic posture still image and the live video of the user to be displayed on a screen.

For example, the basic posture still image may include a plurality of still images including a standby posture still image, a start still image of a gesture, and an end still image of a gesture.

FIG. 3 illustrates a basic posture still image, and may be a standby posture still image.

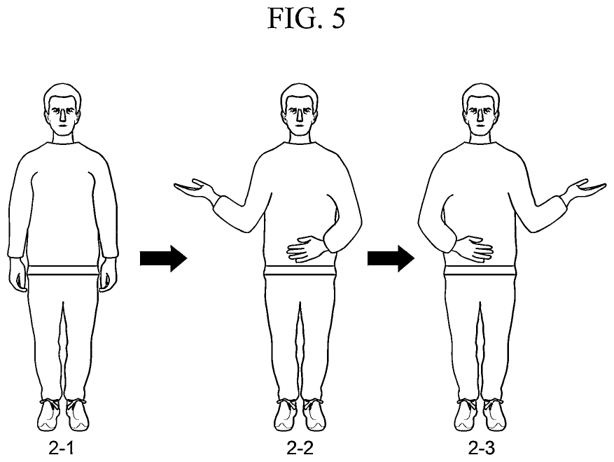

Referring to FIG. 5, 2-1 represents a standing posture and may be the standby posture still image, 2-2 represents a left guidance posture and may be the start still image of a gesture, and 2-3 represents a right guidance posture and may be the end start still image of a gesture.

The image controller 150 may transmit one of the standby posture still image, the start still image of the gesture, and the end still image of the gesture, as a next basic posture still image of the current basic posture still image transmitted to the first monitor 120 to the first monitor, to the first monitor 120 when the image conversion condition is met.

The image controller 150 may determine that the image conversion condition is met when a still image of the live video of the user matches the basic posture still image, or an image conversion request is received from the user terminal, or a preset time elapses after transmitting the basic posture still image to the first monitor while recording the live video of the user. In this case, the still image of the live video of the user may refer to one frame of video that is stopped among a live video of the user being recorded.

The image controller 150 may output a compositing criterion meeting notification when a still image of the live video of the user while recording the live video of the user meets a preset compositing criterion compared to the basic posture still image. In this case, the compositing criterion meeting notification may be output in the form of a text message (e.g., “compositing criterion was met” is displayed in text or emoticon form) or in the form of voice message (e.g., “Ding Dong” or “compositing criterion was met” is output as voice) through the first monitor 120. To this end, a separate notification device may be provided, or it may be output through the first monitor 120 equipped with a voice output function.

The preset compositing criterion described above may be that the still image of the live video of the user is the same as the basic posture still image within an error range. The above compositing intended to prevent unnatural discontinuities that may occur due to differences in the composited portions after multiple videos are composited. The error range may refer to a range in which the still image of the live video of the user and the basic posture still image are recognized as the same. In this case, the error range may be arbitrarily adjusted according to the conditions of the video to be composited. For example, in a case of a video in which the foreground (e.g., the user) and background included in the videos to be composited are relatively enlarged and output, or in a case of a video in which the foreground occupies a relatively large proportion compared to the background, or when the background is a single color, even small differences in a composited portion may be greatly emerged. In this case, the error range may be determined to be a relatively small range.

When comparing the still image of the live video of the user and the basic posture still image, the image controller 150 may compare based on a border of an object, which is an edge. For example, the image controller 150 may compare a user's border in the basic posture still image with a user's border in the still image of the live video of the user. In this case, the user's border may include not only a border of a user's entire body but also a border of each part. For example, the user's border may include borders of all parts of the body, including an entire body border, a face border, a border of each part of the face, a limb border, a hand border, and a finger border. In this case, identifying the user's border may be performed by finding a boundary line where a brightness change rate of a pixel is higher than a reference value on a still image through derivative and gradient operations, but is not limited to this.

The image controller 150 may output guidance on compositing criterion including at least one of a posture change portion for the still image of the live video of the user to match the basic posture still image, a description of the posture change portion, and an identification number of the posture change portion through the first monitor 120 when a still image of the live video of the user while recording the live video of the user does not meet a preset compositing criterion compared to the basic posture still image.

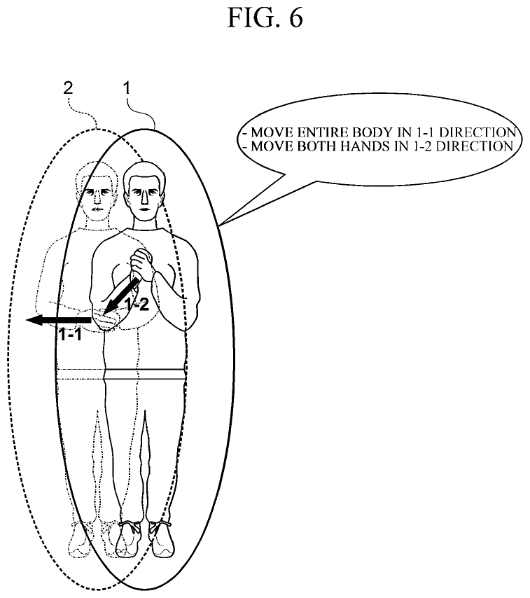

For example, referring to FIG. 6, when a still image 1 of the live video of the user and a basic posture still image 2 are not identically superimposed on each other and do not match, the image controller 150 may generate a posture change portion including the non-matching entire body and both hands, an identification number of the posture change portion (e.g., 1-1 and 1-2), and a description of the posture change portion and output them through the first monitor 120. In this case, the posture change portion may be displayed in a variety of ways, such as displaying a border of a corresponding portion or displaying of highlights on the corresponding portion. Referring to FIG. 6, the description of the posture change part may be such as a description of moving the entire body in a 1-1 direction, a description of moving both hands in a 1-2 direction, etc.

The image controller 150 may manage a plurality of user videos transmitted from the plurality of recording apparatuses by dividing the plurality of user videos into one of a gesture unit and a preset length unit and matching each of the plurality of user videos with at least one of video identification information and recording apparatus's identification information. The plurality of user videos may include videos from different angles.

Meanwhile, when generating a basic posture still image, the image controller 150 may generate the basic posture still image in consideration of a gesture unit and a preset length unit with which the user video is divided. For example, when the image controller 150 generates a basic posture still image, it may include a posture of a gesture unit point and a posture of a preset length unit point.

The image controller 150 may group the plurality of user videos including the videos from different angles into videos of the same angle, or group all of a plurality of user videos recorded at the same time, and manage grouped videos separately. For example, a group of user videos recorded at the same time may include a user's front video, a user's side video, and a user's rear video, etc., recorded at the same time.

Although not illustrated, the image controller 150 may store various data, which is related to the video recording system for compositing, including recorded user videos, in a separate database.

The control panel 160 may be configured to receive control information input by the user and transmit the control information to the image controller 150.

The user terminal 170 may be configured to transmit control information input by the user, including a video change request, to the image controller 150. For example, the user terminal 170 may transmit control information, such as a recording start request and a recording end request, as well as the image conversion change request, to the image controller 150 according to a user's manipulation. The image controller 150 may perform the corresponding operation according to the control information transmitted from the user terminal 170.

The user terminal 170 may be carried by the user who records the video or may be provided within a range that the user can manipulate.

The user terminal 170 has a wireless communication function to transmit and receive information through wireless communication with the image controller 150, but is not limited to this, and may also have a wired communication function.

Generally, when recording a video, video recording is done in such a way that a camera and lighting are set up inside the recording booth, and a director monitors the recording at a control desk located outside the recording booth, and provides directions to a user. In this case, since the recording is carried out only under the direction of the director located outside the recording booth, self-checking by the user, who is a subject to be recorded, is not performed, some difficulties arise in communication with the director.

In this embodiment, since the user located inside the recording booth directly self-checks a state in which a video is recorded through the first monitor 120 and directly performs control related to the video recording using the user terminal 170, it is possible to expect the effect of being able to obtain high-quality video in a state where compositing is easy without separate directing from outside the recording booth.

Generally, when compositing videos, videos containing different user gestures may be connected to utilize as a background video, or a certain section of the background video may be used repeatedly to secure a sufficient compositing length. In this case, a method of connecting two disconnected videos using an interpolation algorithm or machine learning model, or connecting the two disconnected videos at the same point by reversing a playback direction may be applied. In this case, the user's gesture in the video generated by interpolation and the change in a user's body shape may not match, or discontinuity may be felt at a connection point of the composited videos due to movement when the video is played backwards. In the former case, the greater the difference in the user's position or posture at the connection point where interpolation occurs, the more unnaturalness or unreality may increase.

Meanwhile, the training data or background video of a machine learning model to generate continuous gestures may be composed of various gestures such as greeting or pointing these to the left or right. When recording a video, gestures are recorded individually or sequentially, and when learning or compositing the gestures, these gestures may be used by dividing them into gesture units or by a certain length, or used by concatenating them in a random order. In this case, when the positions or postures of the starting and ending parts of individual gestures are different, it may affect user's learning to perform gestures, which may result in the gestures not being smoothly connected within the composite video. In addition, even when used as a background video, disconnections may occur between the concatenated videos.

In this embodiment, when recording training data and user videos for video compositing, in the case of basic speech or standby posture, the user may be guided to accurately return to a specific position and posture at a point in time when speech begins or ends, a preset cycle, or at any point in time. In addition, in this embodiment, the user may be guided to accurately return to a preset basic posture still image after taking various gestures required for compositing. In this case, the image controller 150 may composite basic posture still images by connecting the basic posture still images as they are, or by connecting the basic posture still images using minimal interpolation. In this embodiment, a sophisticated level of posture and gesture control can be performed by setting a small error range in order to ensure natural continuity between composited videos.

In addition, in this embodiment, when the user performs a specific gesture, a basic posture still image that reflects a starting point in time of the corresponding gesture, an ending point in time of the corresponding gesture, and the basic posture position to be returned to after the corresponding gesture may be set and displayed in advance so that the user may accurately recognize his or her current posture and basic posture. Accordingly, in this embodiment, it is possible to expect the effect of being able to more accurately perform an intended gesture with a video for compositing and greatly improving a matching rate when compositing the corresponding gestures during repeated recording.

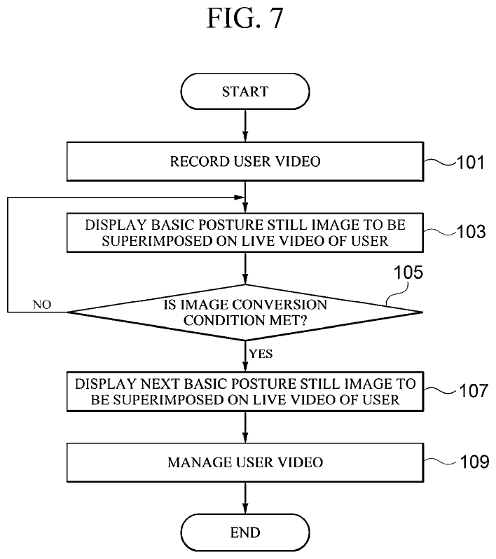

FIG. 7 is a flowchart for describing a video recording method for compositing according to an embodiment. The method illustrated in FIG. 7 may be performed, for example, by the video recording system for compositing 100 described above. In the illustrated flowchart, although the method is described by being divided into a plurality of steps, at least some of the steps may be performed out of order, performed by being combined with other steps, omitted, performed by being divided into detailed steps, or performed by being added with one or more steps not illustrated.

In step 101, the video recording system for compositing 100 may record a user video using the recording apparatus 110. The recording apparatus 110 may include a plurality of recording apparatuses located in different areas to record videos from different angles for a user.

In step 103, the video recording system for compositing 100 may output a live video of the user and a basic posture still image displayed to be superimposed on the live video of the user through the first monitor 120 on the basis of the user video transmitted from the recording apparatus 110.

The basic posture still image may include a plurality of still images including a standby posture still image, a start still image of a gesture, and an end still image of a gesture.

The first monitor 120 may be located inside a recording booth.

In step 103, the video recording system for compositing 100 may output the same information as output information of the first monitor 120 through the second monitor 130 located outside the recording booth. In this case, the second monitor 130 may be a preview monitor that is located outside the recording booth and allows the manager who performs overall directing to monitor and control a video recording process.

Meanwhile, in this embodiment, not only the manager but also the user who is a subject to be recorded located inside the recording booth may self-check the information output through the first monitor 120 and performs directing on recording of the video for compositing on their own. A detailed description of this will be made below.

In step 105, the video recording system for compositing 100 may check whether or not an image conversion condition is met while recording the live video of the user.

In this case, the video recording system for compositing 100 may determine that the image conversion condition is met when a still image of the live video of the user matches the basic posture still image, or an image conversion request is received from the user terminal 170, or a preset time elapses after transmitting the basic posture still image to the first monitor 120 while recording the live video of the user.

When it is checked, in step 105, that the image conversion condition is met, the video recording system for compositing 100 may change the basic posture still image output through the first monitor 120.

In step 107, the video recording system for compositing 100 may transmit one of the standby posture still image, the start still image of the gesture, and the end still image of the gesture, as a next basic posture still image of the current basic posture still image transmitted to the first monitor 120, to the first monitor 120.

Meanwhile, in step 105, the video recording system for compositing 100 may check whether or not a still image of the live video of the user while recording the live video of the user meets a preset compositing criterion compared to the basic posture still image.

When it is checked that the preset compositing criterion is met, the video recording system for compositing 100 may output a compositing criterion meeting notification before the step 107 of changing the basic posture still image, which will be described.

On the other hand, in step 105, the video recording system for compositing 100 may check whether or not a still image of the live video of the user while recording the live video of the user meets a preset compositing criterion compared to the basic posture still image.

When it is checked that the preset compositing criterion is not met, recording system for compositing 100 may return to the step 103 in which the basic posture still image is output through the first monitor 120, and output guidance on compositing criterion including at least one of a posture change portion for the still image of the live video of the user to match the basic posture still image, a description of the posture change portion, and an identification number of the posture change portion through the first monitor 120.

In step 109, the video recording system for compositing 100 may manage a plurality of user videos transmitted from the plurality of recording apparatuses 110 by dividing the plurality of user videos into one of a gesture unit and a preset length unit and matching each of the plurality of user videos with at least one of video identification information and recording apparatus's identification information. The plurality of user videos may include videos from different angles.

In step 109, the video recording system for compositing 100 may group the plurality of user videos including the videos from different angles into videos of the same angle, or group all of a plurality of user videos recorded at the same time, and manage grouped videos separately. For example, a group of user videos group recorded at the same time may include a user's front video, a user's side video, and a user's rear video, etc., recorded at the same time.

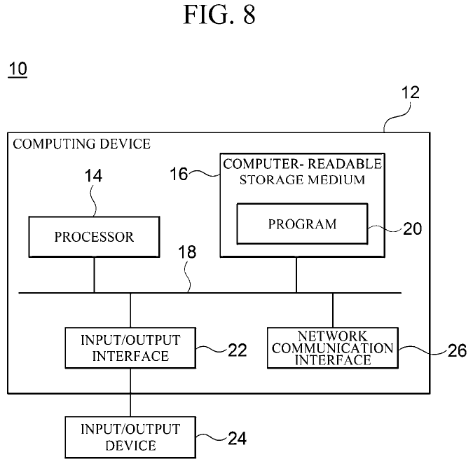

FIG. 8 is a block diagram for illustratively describing a computing environment including a computing device according to an embodiment. In the illustrated embodiment, respective components may have different functions and capabilities other than those described below, and may include additional components in addition to those described below.

The illustrated computing environment 10 includes a computing device 12. In one embodiment, the computing device 12 may be the video recording apparatus for compositing 100.

The computing device 12 includes at least one processor 14, a computer-readable storage medium 16, and a communication bus 18. The processor 14 may cause the computing device 12 to operate according to the exemplary embodiment described above. For example, the processor 14 may execute one or more programs stored on the computer-readable storage medium 16. The one or more programs may include one or more computer-executable instructions, which, when executed by the processor 14, may be configured so that the computing device 12 performs operations according to the exemplary embodiment.

The computer-readable storage medium 16 is configured so that the computer-executable instruction or program code, program data, and/or other suitable forms of information are stored. A program 20 stored in the computer-readable storage medium 16 includes a set of instructions executable by the processor 14. In an embodiment, the computer-readable storage medium 16 may be a memory (volatile memory such as a random access memory, non-volatile memory, or any suitable combination thereof), one or more magnetic disk storage devices, optical disk storage devices, flash memory devices, other types of storage media that are accessible by the computing device 12 and capable of storing desired information, or any suitable combination thereof.

The communication bus 18 interconnects various other including the components of the computing device 12, processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 through the input/output interface 22. The exemplary input/output device 24 may include a pointing device (such as a mouse or trackpad), a keyboard, a touch input device (such as a touch pad or touch screen), a speech or sound input device, input devices such as various types of sensor devices and/or photographing devices, and/or output devices such as a display device, a printer, a speaker, and/or a network card. The exemplary input/output device 24 may be included inside the computing device 12 as a component configuring the computing device 12, or may be connected to the computing device 12 as a separate device distinct from the computing device 12.

According to the embodiments described above, the standby position video and the gesture video can be naturally interpolated through minimal computer graphics work. In addition, according to the present embodiments, gesture videos and gesture videos can be naturally interpolated through minimal computer graphics work. In addition, according to the present embodiments, when compositing video, idle sections within the video can be naturally looped.

Although representative embodiments of the present disclosure have been described in detail, a person skilled in the art to which the present disclosure pertains will understand that various modifications may be made thereto within the limits that do not depart from the scope of the present disclosure. Therefore, the scope of rights of the present disclosure should not be limited to the described embodiments, but should be defined not only by claims set forth below but also by equivalents to the claims.

1. A video recording system for video compositing, comprising:
a first monitor positioned in a gaze area of a user and configured for outputting a live video of the user and a basic posture still image displayed to be superimposed on the live video of the user;
a recording apparatus configured for recording the user; and
an image controller configured for transmitting the basic posture still image and the live video of the user to the first monitor on the basis of a user video transmitted from the recording apparatus, and changing the basic posture still image transmitted to the first monitor when an image conversion condition is met while recording the live video of the user.

2. The video recording system for compositing of claim 1, wherein the basic posture still image includes a plurality of still images including a standby posture still image, a start still image of a gesture, and an end still image of a gesture, and
the image controller transmits one of the standby posture still image, the start still image of the gesture, and the end still image of the gesture, as a next basic posture still image of the current basic posture still image transmitted to the first monitor, to the first monitor when the image conversion condition is met.

3. The video recording system for compositing of claim 1, further comprising:
a user terminal configured for transmitting an image conversion request to the image controller,
wherein the image controller is configured to determine that the image conversion condition is met when a still image of the live video of the user matches the basic posture still image, or an image conversion request is received from the user terminal, or a preset time elapses after transmitting the basic posture still image to the first monitor while recording the live video of the user.

4. The video recording system for compositing of claim 1, wherein the image controller is configured to output a compositing criterion meeting notification when a still image of the live video of the user while recording the live video of the user meets a preset compositing criterion compared to the basic posture still image.

5. The video recording system for compositing of claim 1, wherein the image controller is configured to output guidance on compositing criterion including at least one of a posture change portion for the still image of the live video of the user to match the basic posture still image, a description of the posture change portion, and an identification number of the posture change portion through the first monitor when a still image of the live video of the user while recording the live video of the user does not meet a preset compositing criterion compared to the basic posture still image.

6. The video recording system for compositing of claim 1, wherein the recording apparatus includes a plurality of recording apparatuses located in different areas to record videos from different angles for the user.

7. The video recording system for compositing of claim 6, wherein the image controller is configured to manage a plurality of user videos transmitted from the plurality of recording apparatuses by dividing the plurality of user videos into one of a gesture unit and a preset length unit and matching each of the plurality of user videos with at least one of video identification information and recording apparatus's identification information.

8. The video recording system for compositing of claim 7, wherein the plurality of user videos includes videos from different angles, and
the image controller is configured to group the plurality of user videos including the videos from different angles into videos of the same angle, or configured to group all of a plurality of user videos recorded at the same time and manage grouped videos separately.

9. The video recording system for compositing of claim 1, further comprising:
a second monitor located outside a recording booth and configured for receiving and outputting the same information as the output information of the first monitor transmitted from the image controller.

10. The video recording system for compositing of claim 1, further comprising:
a recorder configured for receiving the user video transmitted from the recording apparatus and transmitting the user video to the image controller; and
a control panel configured for receiving control information input by a user and transmitting the control information to the image controller.

11. The video recording system for compositing of claim 1, wherein the first monitor is located inside the recording booth.

12. A video recording method for compositing, comprising:
recording a user video using a recording apparatus;
outputting a live video of a user and a basic posture still image displayed to be superimposed on the live video of the user through the first monitor on the basis of a user video transmitted from the recording apparatus;
checking whether an image conversion condition is met while recording the live video of the user; and
changing the basic posture still image output through the first monitor when it is checked that the image conversion condition is met.

13. The video recording method for compositing of claim 12, wherein the basic posture still image includes a plurality of still images including a standby posture still image, a start still image of a gesture, and an end still image of a gesture, and
in the changing of the basic posture still image, one of the standby posture still image, the start still image of the gesture, and the end still image of the gesture, as a next basic posture still image of the current basic posture still image is transmitted to the first monitor, to the first monitor.

14. The video recording method for compositing of claim 12, wherein, in the checking of whether the image conversion condition is met, it is determined that the image conversion condition is met when a still image of the live video of the user matches the basic posture still image, or an image conversion request is received from the user terminal, or a preset time elapses after transmitting the basic posture still image to the first monitor while recording the live video of the user.

15. The video recording method for compositing of claim 12, wherein, in the checking of whether the image conversion condition is met,
it is checked whether a still image of the live video of the user while recording the live video of the user meets a preset compositing criterion compared to the basic posture still image, and
when it is checked that the preset compositing criterion is met, a compositing criterion meeting notification is output before the changing of the basic posture still image.

16. The video recording method for compositing of claim 12, wherein, in the checking of whether the image conversion condition is met,
it is checked whether a still image of the live video of the user while recording the live video of the user meets a preset compositing criterion compared to the basic posture still image, and
when it is checked that the preset compositing criterion is not met, in the outputting of the basic posture still image through the first monitor, guidance on compositing criterion including at least one of a posture change portion for the still image of the live video of the user to match the basic posture still image, a description of the posture change portion, and an identification number of the posture change portion is output through the first monitor.

17. The video recording method for compositing of claim 12, wherein the recording apparatus includes a plurality of recording apparatuses located in different areas to record videos from different angles for the user, and
the video recording method for compositing further comprises managing a plurality of user videos transmitted from the plurality of recording apparatuses by dividing the plurality of user videos into one of a gesture unit and a preset length unit and matching each of the plurality of user videos with at least one of video identification information and recording apparatus's identification information.

18. The video recording method for compositing of claim 17, wherein the plurality of user videos includes videos from different angles, and
in the managing, the plurality of user videos including the videos from different angles are grouped into videos of the same angle, or all of a plurality of user videos recorded at the same time are grouped, and grouped videos are managed separately.

19. The video recording method for compositing of claim 12, wherein the first monitor is located inside a recording booth, and
in the outputting of the live video of the user and the basic posture still image through the first monitor, the same information as the output information of the first monitor is output through a second monitor located outside the recording booth.
